(19) United States
(12) Patent Application Publication
(10) Pub. No.: US 2026/0132256 A1
(43) Pub. Date: May 14, 2026

(54) POLYAMIC ACID COMPOSITION AND POLYIMIDE PREPARED WITH THE SAME

(71) Applicant: PI Advanced Materials Co., Ltd., Chungcheongbuk-Do (KR)

(72) Inventors: Kyuwon Lee, Chungcheongbuk-Do (KR); Jeong Jae Hwang, Chungcheongbuk-Do (KR); Han Tae Ryu, Chungcheongbuk-Do (KR); Kil Nam Lee, Chungcheongbuk-Do (KR)

(21) Appl. No.: 19/388,322

(22) Filed: Nov. 13, 2025

(30) Foreign Application Priority Data
Nov. 13, 2024 (KR) 10-2024-0161430
Oct. 16, 2025 (KR) 10-2025-0149735

(51) Int. Cl. C08G 73/10; C08K 5/3472

(52) U.S. Cl. CPC C08G 73/1042; C08G 73/105; C08G 73/1071; C08K 5/3472

(57) ABSTRACT

The present disclosure provides a polyamic acid composition comprising: a polyamic acid including a dianhydride monomer and a diamine monomer as polymerization units; and an additive containing imidazole, wherein the additive has an amount of 0.01 to 5 parts by weight based on 100 parts by weight of the polyamic acid.

### TECHNICAL FIELD

The present disclosure relates to a polyamic acid composition and a polyimide prepared therefrom. More particularly, the present disclosure relates to a polyamic acid composition capable of preparing a polyimide having excellent mechanical properties by comprising an additive containing imidazole.

### BACKGROUND ART

In general, polyimide (PI) is a polymer material having the highest level of heat resistance, chemical resistance, electrical insulation, chemical resistance, and weather resistance among organic materials based on an imide ring having excellent chemical stability together with a rigid aromatic backbone, and may be prepared in various forms such as films, fibers, and membranes. Due to these characteristics, polyimide is used in a wide range of fields as advanced materials and insulating coatings in the fields of electrical and electronic, semiconductor, display, automotive, aviation, and space materials.

Recently, as various electronic devices have become thinner, lighter, and smaller, extensive research has been conducted on the use of thin polyimide films, which are lightweight and highly flexible, as display substrates capable of replacing conventional insulating materials in circuit boards or glass substrates in displays.

Polyimide may be prepared by dissolving an acid dianhydride having two acid anhydride groups in a molecule and a diamine having two amino groups in a molecule in a solvent, synthesizing a polyimide precursor called polyamic acid (PAA), followed by applying and drying the polyimide precursor, and heat-treatment at a temperature of about 350° C. to induce imidization.

Meanwhile, the conventional polyamic acid composition has problems in that it has a structure like beads on a string and has poor mechanical properties, although it exhibits electrospinnability during electrospinning.

Therefore, it is necessary to develop a polyimide having improved electrospinnability, relatively high molecular weight, and excellent mechanical properties.

### DISCLOSURE

### Technical Problem

An object of the present disclosure is to provide a polyimide having a relatively high molecular weight and excellent mechanical properties, and a polyamic acid composition capable of preparing the same.

In addition, another object of the present disclosure is to provide a polyamic acid composition having improved electrospinnability without chemical crosslinking.

Further, still another object of the present disclosure to provide a polyamic acid composition capable of preparing a polyimide that is usable as a secondary battery separator, membrane, film or coating material.

### Technical Solution

Various modifications can be made and various embodiments may be implemented in the present disclosure, and specific embodiments are illustrated in the drawings and described in detail. However, it should be understood that this is not intended to limit the present disclosure to specific embodiments, and comprises all modifications, equivalents, and substitutes included in the spirit and scope of the present disclosure.

Terms used in the present application are only used to describe specific embodiments and are not intended to limit the present disclosure. Singular expressions shall include plural expressions unless the context clearly indicates otherwise. In the present specification, terms such as “comprise” or “have” are intended to designate the presence of features, numbers, steps, operations, components, parts, or combinations thereof described in the specification and it should not be understood as precluding the possibility of the presence or addition of one or more other features, numbers, steps, operations, components, parts, or combinations thereof.

When amounts, concentrations, or other values or parameters herein are given as ranges, preferred ranges, or lists of upper desirable values and lower desirable values, it should be understood as specifically disclosing all ranges formed by any pair of any upper range limit or preferred value and any lower range limit or preferred value, regardless of whether the scope is separately disclosed.

When ranges of numerical values are stated herein, unless otherwise stated, it is intended that the endpoints of the range and the scope of the parent invention within the range are not limited to the specific values stated when defining the range.

As used herein, “dianhydride” is intended to include precursors or derivatives thereof, which are also referred to as “dianhydride acid”, “dianhydride” or “acid dianhydride”. These products may technically not be dianhydrides, but will nonetheless react with diamines to form polyamic acids, and the polyamic acids may be converted back into polyimides.

As used herein, “diamine” is intended to include precursors or derivatives thereof, which may technically not be diamines, but will nonetheless react with dianhydride acids to form polyamic acids, and the polyamic acids may be converted back into polyimides.

Unless otherwise defined, all terms used herein, including technical or scientific terms, have the same meanings as those generally understood by those skilled in the art to which the present disclosure pertains. It should be further understood that terms commonly defined in dictionaries are to be interpreted in a manner consistent with their meaning as understood in the relevant technical field and the context of the present disclosure, and not in an idealized or unduly formal sense, unless explicitly defined otherwise herein. Specific details for implementing the present disclosure will be described as follows.

The present disclosure relates to a polyamic acid composition and a polyimide prepared therefrom.

Specifically, the present disclosure provides a polyamic acid composition comprising: a polyamic acid including a dianhydride monomer and a diamine monomer as polymerization units; and an additive containing imidazole, wherein the additive has an amount of 0.01 to 5 parts by weight based on 100 parts by weight of the polyamic acid.

Here, the imidazole is an imidazole represented by the following Structural Formula 1:

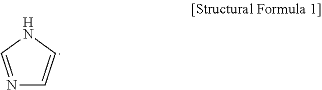

Here, the polyamic acid composition may comprise the additive in an amount of 0.01 to 5 parts by weight, preferably 0.01 to 3 parts by weight, 0.01 to 2.5 parts by weight, 0.01 to 2 parts by weight, 0.01 to 1.5 parts by weight, 0.01 to 1 part by weight, 0.01 to 0.5 parts by weight, 0.01 to 0.15 parts by weight, 0.1 to 5 parts by weight, 0.1 to 3 parts by weight, 0.1 to 2.5 parts by weight, 0.1 to 2 parts by weight, 0.1 to 1.5 parts by weight, 0.1 to 1 part by weight, 0.1 to 0.5 parts by weight, 0.15 to 5 parts by weight, 0.15 to 3 parts by weight, 0.15 to 2.5 parts by weight, 0.15 to 2 parts by weight, 0.15 to 1.5 parts by weight, 0.15 to 1 part by weight, 0.1 to 0.5 parts by weight, 0.2 to 5 parts by weight, 0.2 to 3 parts by weight, 0.2 to 2.5 parts by weight, 0.2 to 2 parts by weight, 0.2 to 1.5 parts by weight, 0.2 to 1 part by weight, 0.1 to 0.5 parts by weight, 0.3 to 5 parts by weight, 0.3 to 3 parts by weight, 0.3 to 2.5 parts by weight, 0.3 to 2 parts by weight, 0.3 to 1.5 parts by weight, 0.3 to 1 part by weight, 0.1 to 0.5 parts by weight, 0.4 to 5 parts by weight, 0.4 to 3 parts by weight, 0.4 to 2.5 parts by weight, 0.4 to 2 parts by weight, 0.4 to 1.5 parts by weight, 0.4 to 1 part by weight, 0.4 to 0.5 parts by weight, 0.5 to 5 parts by weight, 0.5 to 3 parts by weight, 0.5 to 2.5 parts by weight, 0.5 to 2 parts by weight, 0.5 to 1.5 parts by weight, 0.5 to 1 part by weight, 1 to 5 parts by weight, 1 to 3 parts by weight, 1 to 2.5 parts by weight, 1 to 2 parts by weight, 1 to 1.5 parts by weight or 3 to 5 parts by weight, more preferably, 0.1 to 3 parts by weight, 0.2 to 2.5 parts by weight, 0.3 to 2 parts by weight, 0.4 to 1.5 parts by weight, and even more preferably 0.5 to 1 part by weight.

When the additive is contained in an amount of less than 0.01 part by weight, it is not preferable since mechanical properties are deteriorated, and when the additive is contained in an amount of more than 5 parts by weight, viscosity and molecular weight are reduced at room temperature or frozen storage, rendering storage difficult, and electrospinnability is deteriorated, which is not preferable.

Imidazole in the present disclosure is not contained as an imidization catalyst, but as an additive for improving electrospinnability of polyamic acid. The additive significantly improves the electrospinning stability even in a small amount of 0.01 to 5 parts by weight based on 100 parts by weight of the polyamic acid, and the polyimide film prepared therefrom exhibits excellent mechanical properties. The dianhydride monomer may comprise at least one selected from the group consisting of biphenyl tetracarboxylic dianhydride (BPDA), pyromellitic dianhydride (PMDA), 3,3′,4,4′-benzophenonetetracarboxylic dianhydride (BTDA), oxydiphthalic dianhydride (ODPA), diphenylsulfone-3,4,3′,4′-tetracarboxylic dianhydride (DSDA), bis(3,4-dicarboxyphenyl)sulfide dianhydride, 2,2-bis(3,4-dicarboxyphenyl)-1,1,1,3,3,3-hexafluoropropane dianhydride, 2,3,3′,4′-benzophenonetetracarboxylic dianhydride, bis(3,4-dicarboxyphenyl)methane dianhydride, 2,2-bis(3,4-dicarboxyphenyl)propane dianhydride, p-phenylenebis(trimellitic monoester acid anhydride), p-biphenylenebis(trimellitic monoester acid anhydride), m-terphenyl-3,4,3′,4′-tetracarboxylic dianhydride, p-terphenyl-3,4,3′,4′-tetracarboxylic dianhydride, 1,3-bis(3,4-dicarboxyphenoxy)benzene dianhydride, 1,4-bis(3,4-dicarboxyphenoxy)benzene dianhydride, 1,4-bis(3,4-dicarboxyphenoxy)biphenyl dianhydride, 2,2-bis[(3,4-dicarboxyphenoxy)phenyl]propane dianhydride (BPADA), 2,3,6,7-naphthalenetetracarboxylic acid dianhydride, 1,4,5,8-naphthalenetetracarboxylic dianhydride, and 4,4′-(2,2-hexafluoroisopropylidene)diphthalic acid dianhydride, and preferably may comprise at least one selected from the group consisting of biphenyl tetracarboxylic dianhydride (BPDA) and pyromellitic dianhydride (PMDA), and more preferably may comprise biphenyl tetracarboxylic dianhydride (BPDA).

Specifically, the dianhydride monomer may comprise 90 mol % or more of the biphenyl tetracarboxylic dianhydride (BPDA) based on a total of 100 mol % of the dianhydride monomer. By containing 90 mol % or more of the biphenyl tetracarboxylic dianhydride, it is possible to prepare a polyimide having excellent desired mechanical properties.

Meanwhile, the dianhydride monomer may comprise biphenyl tetracarboxylic dianhydride (BPDA), and may further comprise at least one selected from the group consisting of pyromellitic dianhydride (PMDA), 3,3′,4,4′-benzophenonetetracarboxylic dianhydride (BTDA), oxydiphthalic dianhydride (ODPA), diphenylsulfone-3,4,3′,4′-tetracarboxylic dianhydride (DSDA), bis(3,4-dicarboxyphenyl)sulfide dianhydride, 2,2-bis(3,4-dicarboxyphenyl)-1,1,1,3,3,3-hexafluoropropane dianhydride, 2,3,3′,4′-benzophenonetetracarboxylic dianhydride, bis(3,4-dicarboxyphenyl)methane dianhydride, 2,2-bis(3,4-dicarboxyphenyl)propane dianhydride, p-phenylenebis(trimellitic monoester acid anhydride), p-biphenylenebis(trimellitic monoester acid anhydride), m-terphenyl-3,4,3′,4′-tetracarboxylic dianhydride, p-terphenyl-3,4,3′,4′-tetracarboxylic dianhydride, 1,3-bis(3,4-dicarboxyphenoxy)benzene dianhydride, 1,4-bis(3,4-dicarboxyphenoxy)benzene dianhydride, 1,4-bis(3,4-dicarboxyphenoxy)biphenyl dianhydride, 2,2-bis[(3,4-dicarboxyphenoxy)phenyl]propane dianhydride (BPADA), 2,3,6,7-naphthalenetetracarboxylic acid dianhydride, 1,4,5,8-naphthalenetetracarboxylic dianhydride, and 4,4′-(2,2-hexafluoroisopropylidene)diphthalic acid dianhydride. Preferably, pyromellitic dianhydride (PMDA) may be further included.

The diamine monomer may comprise at least one selected from the group consisting of 4,4′-diaminodiphenyl ether (4,4′-ODA), 1,4-diaminobenzene (PPD), 2,2′-bis(trifluoromethyl)-4,4′-diaminobiphenyl (TFMB), 2,2′-dimethyl-4,4′-diaminobiphenyl (m-tolidine), 2,2-bisaminophenoxyphenylpropane (BAPP), metaphenylenediamine, 3,3′-dimethylbenzidine, 2,2′-dimethylbenzidine, 2,4-diaminotoluene, 2,6-diaminotoluene, 3,5-diaminobenzoic acid (DABA), 3,3′-dimethyl-4,4′-diaminobiphenyl, 3,3′-dimethyl-4,4′-diaminodiphenylmethane, 3,3′-dicarboxy-4,4′-diaminodiphenylmethane, 3,3′,5,5′-tetramethyl-4,4′-diaminodiphenylmethane, 4,4′-diaminobenzanilide, 3,3′-dimethoxybenzidine, 2,2′-dimethoxybenzidine, 3,3′-diaminodiphenyl ether, 3,3′-diaminodiphenyl sulfide, 3,4′-diaminodiphenyl sulfide, 4,4′-diaminodiphenyl sulfide, 3,3′-diaminodiphenyl sulfone, 3,4′-diaminodiphenyl sulfone, 4,4′-diaminodiphenyl sulfone, 3,3′-diaminobenzophenone, 4,4′-diaminobenzophenone, 3,3′-diamino-4,4′-dichlorobenzophenone, 3,3′-diamino-4,4′-dimethoxybenzophenone, 3,3′-diaminodiphenylmethane, 3,4′-diaminodiphenylmethane, 4,4′-diaminodiphenylmethane, 2,2-bis(3-aminophenyl)propane, 2,2-bis(4-aminophenyl)propane, 2,2-bis(3-aminophenyl)-1,1,1,3,3,3-hexafluoropropane, 2,2-bis(4-aminophenyl)-1,1,1,3,3,3-hexafluoropropane, 3,3′-diaminodiphenylsulfoxide, 3,4′-diaminodiphenylsulfoxide, 4,4′-diaminodiphenylsulfoxide, 1,3-bis(3-aminophenyl)benzene, 1,3-bis(4-aminophenyl)benzene, 1,4-bis(3-aminophenyl)benzene, 1,4-bis(4-aminophenyl)benzene, 1,3-bis(4-aminophenoxy)benzene (TPE-R), 1,4-bis(3-aminophenoxy)benzene (TPE-Q), 1,3-bis(3-aminophenoxy)-4-trifluoromethylbenzene, 3,3′-diamino-4-(4-phenyl)phenoxybenzophenone, 3,3′-diamino-4,4′-di(4-phenylphenoxy)benzophenone, 1,3-bis(3-aminophenylsulfide)benzene, 1,3-bis(4-aminophenylsulfide)benzene, 1,4-bis(4-aminophenylsulfide)benzene, 1,3-bis(3-aminophenylsulfone)benzene, 1,3-bis(4-aminophenylsulfone)benzene, 1,4-bis(4-aminophenylsulfone)benzene, 1,3-bis[2-(4-aminophenyl)isopropyl]benzene, 1,4-bis[2-(3-aminophenyl)isopropyl]benzene, 1,4-bis[2-(4-aminophenyl)isopropyl]benzene, 3,3′-bis(3-aminophenoxy)biphenyl, 3,3′-bis(4-aminophenoxy)biphenyl, 4,4′-bis(3-aminophenoxy)biphenyl, 4,4′-bis(4-aminophenoxy)biphenyl, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, bis[3-(3-aminophenoxy)phenyl]ketone, bis[3-(4-aminophenoxy)phenyl]ketone, bis[4-(3-aminophenoxy) phenyl]ketone, bis[4-(4-aminophenoxy)phenyl]ketone, bis[3-(3-aminophenoxy)phenyl]sulfide, bis[3-(4-aminophenoxy)phenyl]sulfide, bis[4-(3-aminophenoxy)phenyl]sulfide, bis[4-(4-aminophenoxy)phenyl]sulfide, bis[3-(3-aminophenoxy)phenyl]sulfone, bis[3-(4-aminophenoxy)phenyl]sulfone, bis[4-(3-aminophenoxy)phenyl]sulfone, bis[4-(4-aminophenoxy)phenyl]sulfone, bis[3-(3-aminophenoxy)phenyl]methane, bis[3-(4-aminophenoxy)phenyl]methane, bis[4-(3-aminophenoxy)phenyl]methane, bis[4-(4-aminophenoxy)phenyl]methane, 2,2-bis[3-(3-aminophenoxy)phenyl]propane, 2,2-bis[3-(4-aminophenoxy)phenyl]propane, 2,2-bis[4-(3-aminophenoxy)phenyl]propane, 2,2-bis[3-(3-aminophenoxy)phenyl]-1,1,1,3,3,3-hexafluoropropane, 2,2-bis[3-(4-aminophenoxy)phenyl]-1,1,1,3,3,3-hexafluoropropane, 2,2-bis[4-(3-aminophenoxy) phenyl]-1,1,1,3,3,3-hexafluoropropane, and 2,2-bis[4-(4-aminophenoxy)phenyl]-1,1,1,3,3,3-hexafluoropropane, and preferably may comprise at least one selected from the group consisting of 1,4-diaminobenzene (PPD) and 4,4′-diaminodiphenyl ether (ODA).

The diamine monomer may comprise 50 mol % or more of the 1,4-diaminobenzene (PPD), specifically 50 to 100 mol %, 55 to 90 mol %, 60 to 85 mol %, 65 to 80 mol %, or 68 to 75 mol %, based on a total of 100 mol % of the diamine monomer. When 1,4-diaminobenzene (PPD) is contained in an amount of 100 mol %, 4,4′-diaminodiphenyl ether (ODA) may be contained in an amount of 0 mol %.

The diamine monomer may comprise 50 mol % or less of the 4,4′-diaminodiphenyl ether (ODA), specifically 0 to 50 mol %, 10 to 45 mol %, 15 to 40 mol %, 20 to 35 mol %, or 25 to 32 mol % based on a total of 100 mol % of the diamine monomer. When 4,4′-diaminodiphenyl ether (ODA) is contained in an amount of 0 mol %, 1,4-diaminobenzene (PPD) may be contained in an amount of 100 mol %.

In other words, the sum of the amount of the 1,4-diaminobenzene (PPD) and the amount of the 4,4′-diaminodiphenyl ether (ODA) may be 100 mol % based on 100 mol % of the total amount of the diamine monomer.

By containing 50 mol % or more of the 1,4-diaminobenzene (PPD) (50 mol % or less of 4,4′-diaminodiphenyl ether (ODA)) as the diamine monomer, a polyimide having excellent desired mechanical properties may be prepared.

In an embodiment, the polyamic acid may comprise biphenyl tetracarboxylic dianhydride (BPDA), 1,4-diaminobenzene (PPD), and 4,4′-diaminodiphenyl ether (ODA) as polymerization units.

In an embodiment, the polyamic acid may comprise biphenyl tetracarboxylic dianhydride (BPDA), pyromellitic dianhydride (PMDA), 1,4-diaminobenzene (PPD), and 4,4′-diaminodiphenyl ether (ODA) as polymerization units.

A molar ratio of the dianhydride monomer to the diamine monomer may be 6:4 to 4:6, preferably 5.5:4.5 to 4.5:6.5, and more preferably 5:5.

The polyamic acid may comprise the diamine monomer in an amount of 90 to 110 mol %, preferably 95 to 105 mol %, more preferably 98 to 102 mol %, and still more preferably 99 to 101 mol %.

The polyamic acid may comprise the dianhydride monomer in an amount of 90 to 110 mol %, preferably 95 to 105 mol %, more preferably 98 to 102 mol %, and even more preferably 100 mol %.

The polyamic acid may comprise the dianhydride monomer in an amount of 95 to 105 mol % based on 100 mol % of the diamine monomer. For example, the lower limit of the amount of the dianhydride monomer may be 95.5 mol % or more, 96 mol % or more, 96.5 mol % or more, 97 mol % or more, 97.5 mol % or more, 98 mol % or more, 98.5 mol % or more, 99 mol % or more, or 99.5 mol % or more, and the upper limit thereof may be 105 mol % or less, 104 mol % or less, 103 mol % or less, 102 mol % or less, 101 mol % or less, or 100 mol % or less.

The polyamic acid composition may further comprise a solvent.

The solvent may comprise at least one selected from the group consisting of N,N′-dimethylacetamide (DMAc), N,N′-dimethylformamide (DMF), N-methyl-2-pyrrolidone (M4P), dimethylsulfoxide (DMSO), diethylacetamide (DEAc), N-ethyl-2-pyrrolidone (NEP), N,N′-diethylformamide (DEF), dimethylpropanamide (DMPA), and gamma butyrolactone (GBL), and preferably, N,N′-dimethylacetamide (DMAc) may be used.

The polyamic acid composition may have a viscosity of 5,000 to 300,000 cP.

The weight average molecular weight (Mw) of the polyamic acid composition is preferably 10,000 to 500,000 (g/mol), more preferably 100,000 to 400,000 (g/mol), 150,000 to 350,000 (g/mol), 180,000 to 320,000 (g/mol), and even more preferably 200,000 to 300,000. When the molecular weight of the polyamic acid composition is 10,000 to 500,000, it is preferable since electrospinning is smoothly performed, thereby improving process stability. It may be confirmed that the polyamic acid composition of the present disclosure has a higher molecular weight than the conventional polyamic acid composition that does not contain imidazole.

In an embodiment, the polyamic acid composition may have a modulus of 4 GPa or more after curing. For example, the lower limit of the modulus may be 4.5 GPa or more, 4.7 GPa or more, or 5 GPa or more. In addition, the upper limit of the modulus is not particularly limited, but may be 18 GPa or less, 17 GPa or less, 16 GPa or less, or 15 GPa or less. The modulus may be determined by preparing samples of 220 mm in length and 15 mm in width, measuring the modulus at a rate of 10 mm/min using INSTRON's Instron 5564 universal testing machine (UTM), and calculating the average of 10 samples.

In an embodiment, the polyamic acid composition may have a tensile strength of 180 MPa or more after curing. For example, the lower limit of the tensile strength may be 190 MPa or more, 195 MPa or more, 200 MPa or more, 205 MPa or more, 210 MPa or more, 215 MPa or more, or 220 MPa or more. In addition, the upper limit of the tensile strength is not particularly limited, but may be 400 MPa or less. The tensile strength may be determined by preparing samples of 220 mm in length and 15 mm in width, measuring the tensile strength at a grip interval (50 mm) and a rate (10 mm/min) using INSTRON's Instron 5564 UTM according to the ASTM D-882 standard, and calculating the average of 10 samples.

In an embodiment, the polyamic acid composition may have an elongation of 9% or more after curing. For example, the lower limit of the elongation may be 10% or more, 11% or more, 12% or more, 12.5% or more, 12.8% or more, or 13% or more. In addition, the upper limit of the elongation is not particularly limited, but may be 80% or less. In an embodiment, the elongation may be determined by preparing a sample of 220 mm in length and 15 mm in width and measuring an elongation at a rate (10 mm/min) using INSTRON's Instron 5564 UTM according to the ASTM D-882 standard.

Another embodiment of the present disclosure provides a polyimide comprising a cured product of the polyamic acid composition.

Still another embodiment of the present disclosure provides a polyimide film prepared using the polyamic acid composition.

A thickness of the polyimide film may be appropriately selected in consideration of the use, operating environment, physical properties, and the like of the polyimide film. For example, the thickness of the polyimide film may be 1 to 100 μm, 15 to 70 μm, 25 to 50 μm, or 30 to 45 μm, but is not limited thereto.

### Advantageous Effects

The polyamic acid composition according to the present disclosure may provide a polyimide having a relatively high molecular weight and excellent mechanical properties.

In addition, the polyamic acid composition according to the present disclosure may improve electrospinnability (processability) by using an additive containing imidazole without chemical crosslinking.

Further, the polyamic acid composition and the polyimide prepared therefrom according to the present disclosure may be applied to secondary battery separators, membranes, films, or coating materials.

### DESCRIPTION OF DRAWINGS

FIG. 1 is a scanning electron microscope (SEM) image of a polyamic acid composition prepared according to Example 1-1 after electrospinning.

FIG. 2 is a scanning electron microscope (SEM) image of a polyamic acid composition prepared according to Example 1-2 after electrospinning.

FIG. 3 is a scanning electron microscope (SEM) image of a polyamic acid composition prepared according to Comparative Example 1-1 after electrospinning.

FIG. 4 shows images of polyamic acid compositions prepared according to Examples 1-2, 1-5, and Comparative Example 1-6 after storage in a freezer (−15° C.).

### BEST MODE

Examples are presented to facilitate understanding of the present invention. The following Examples are provided only to more easily understand the present invention, and the contents of the present invention are not limited by these Examples.

### Example 1. Polyamic Acid Composition

### Example 1-1

To an N,N′-dimethylacetamide (DMAc) organic solvent, 70 mol % of 1,4-diaminobenzene (PPD) was added and dissolved under a nitrogen/35° C. atmosphere. Then, 100 mol % of biphenyl tetracarboxylic dianhydride (BPDA) was added thereto and stirred for 3 hours. Subsequently, 30 mol % of 4,4′-diaminodiphenyl ether (ODA) was added to obtain a polyamic acid. Imidazole (1,500 ppm, corresponding to 0.15 parts by weight based on 100 parts by weight of the obtained polyamic acid) was mixed with the obtained polyamic acid as an additive, and then stirred for 1 hour to prepare a polyamic acid composition.

### Examples 1-2 to 1-9 and Comparative Examples 1-1 to 1-6

Each polyamic acid composition was prepared in the same manner as in Example 1-1, except that the type and amount of the dianhydride monomer and diamine monomer used, and the type and amount of the additive used were changed as shown in Table 1.

The types and amounts of the monomers/additives used in the preparation of the polyamic acid compositions according to Examples 1-1 to 1-9 and Comparative Examples 1-1 to 1-6 are shown in Table 1 below.

TABLE 1

| | Dianhydride | | Diamine | | Additive (ppm) | | |
|---|---|---|---|---|---|---|---|
| | Monomer | | Monomer | | | | 1,2- |
| | (mol %) | | (mol %) | | | 2-Phenyl | Dimethyl |
| Classification | BPDA | PMDA | PPD | ODA | Imidazole | imidazole | imidazole |
| Example 1-1 | 100 | — | 70 | 30 | 1,500 | — | — |
| Example 1-2 | 100 | — | 70 | 30 | 5,000 | — | — |
| Example 1-3 | 100 | — | 70 | 30 | 10,000 | — | — |
| Example 1-4 | 100 | | 70 | 30 | 30,000 | — | — |
| Example 1-5 | 100 | — | 70 | 30 | 50,000 | — | — |
| Example 1-6 | 100 | — | 65 | 35 | 10,000 | — | — |
| Example 1-7 | 90 | 10 | 80 | 20 | 5,000 | — | — |
| Example 1-8 | 97 | 3 | 65 | 35 | 1,500 | — | — |
| Example 1-9 | 95 | 5 | 60 | 40 | 1,500 | — | — |
| Comparative | 100 | — | 70 | 30 | — | — | — |
| Example 1-1 | | | | | | | |
| Comparative | 90 | 10 | 90 | 10 | — | — | — |
| Example 1-2 | | | | | | | |
| Comparative | 40 | 60 | 25 | 75 | — | — | — |
| Example 1-3 | | | | | | | |
| Comparative | 100 | — | 70 | 30 | — | 5,000 | — |
| Example 1-4 | | | | | | | |
| Comparative | 100 | — | 70 | 30 | — | — | 5,000 |
| Example 1-5 | | | | | | | |
| Comparative | 100 | — | 70 | 30 | 51,000 | — | — |
| Example 1-6 | | | | | | | |

The abbreviations in Table 1 are as follows.
BPDA: biphenyl tetracarboxylic dianhydride
PMDA: pyromellitic dianhydride
PPD: paraphenylene diamine
ODA: 4,4′-diaminodiphenyl ether

### Example 2: Polyimide Film

### Example 2-1

The polyamic acid composition prepared according to Example 1-1 was coated on a glass substrate to a thickness of 20 μm using spin coating, and the temperature was gradually raised to 90° C., 170° C., 200° C., and 400° C. to obtain a polyimide film.

### Examples 2-2 to 2-9 and Comparative Examples 2-1 to 2-6

Polyimide films were prepared in the same manner as in Example 2-1, except that the polyamic acid compositions were changed to Examples 1-1 to 1-9 and Comparative Examples 1-1 to 1-6, respectively.

### EXPERIMENTAL EXAMPLES

### Experimental Example 1. Confirmation of Molecular Weight of Polyamic Acid Composition

In order to confirm the change in molecular weight according to the imidazole amount, the weight average molecular weight (Mw) of the polyamic acid compositions prepared according to Examples 1-1 to 1-5 and Comparative Examples 1-1 and 1-6 is shown in Table 2 below.

Specifically, gel permeation chromatography (GPC) analysis was performed to confirm the weight average molecular weight (Mw) of the polyamic acid compositions prepared according to Examples 1-1 to 1-5 and Comparative Examples 1-1 and 1-6. Analysis was performed using a Agilent 1260 Infinity II GPC/SEC system and a Agilent PLgel Mixed-C column (300×7.5 mm, 5 μm). N-methyl-2-pyrrolidone (NMP) was used as the mobile phase, and the flow rate was set to 1.0 mL/min and the column temperature was set to 50° C. A differential refractive index detector was used as the detector, and the sample was dissolved in NMP at a concentration of 2 mg/mL, filtered through a 0.20 μm PTFE filter, and injected. Molecular weight calibration was performed using monodisperse polystyrene standard samples.

TABLE 2

| Classification | Weight Average Molecular Weight (g/mol) |
|---|---|
| Example 1-1 | 210,987 |
| Example 1-2 | 221,000 |
| Example 1-3 | 250,878 |
| Example 1-4 | 261,200 |
| Example 1-5 | 270,000 |
| Comparative Example 1-1 | 204,000 |
| Comparative Example 1-6 | 282,124 |

According to Table 2, it was confirmed that the molecular weight of the polyamic acid composition also increased as the amount of imidazole increased in the same polyamic acid composition (BPDA 100 mol %, PPD 70 mol %, ODA 30 mol %).

### Experimental Example 2. Evaluation of Mechanical Properties

In order to compare the mechanical properties (modulus, tensile strength, and elongation) according to the addition of imidazole, physical properties of the polyimide films (Examples 2-1 and 2-2, Comparative Examples 2-1, 2-4, and 2-5) prepared from the polyamic acid compositions (Examples 1-1 and 1-2, and Comparative Examples 1-1, 1-4, and 1-5) having the same dianhydride monomer and diamine monomer amounts were confirmed by the following method.

### (1) Modulus

With respect to the polyimide films of Examples 2-1 and 2-2 and Comparative Examples 2-1, 2-4 and 2-5, polyimide film samples with 220 mm in length and 15 mm in width were prepared, and the modulus was determined by using INSTRON's Instron 5564 universal testing machine (UTM) at a rate of 10 mm/min. The average of 10 samples was calculated and shown in Table 3 below.

### (2) Tensile Strength

With respect to the polyimide films of Examples 2-1 and 2-2 and Comparative Examples 2-1, 2-4 and 2-5, polyimide film samples with 220 mm in length and 15 mm in width were prepared, and the tensile strength was determined by using INSTRON's Instron 5564 universal testing machine (UTM) with a grip interval (50 mm) and a rate (10 mm/min) according to ASTM D-882 standard. The average of 10 samples was calculated and shown in Table 3 below.

### (3) Elongation

With respect to the polyimide films of Examples 2-1 and 2-2 and Comparative Examples 2-1, 2-4 and 2-5, polyimide film samples with 220 mm in length and 15 mm in width were prepared, and the elongation was determined by using INSTRON's Instron 5564 UTM at a rate of 10 mm/min according to ASTM D-882 standard. The average of samples was calculated and shown in Table 3 below.

TABLE 3

| | Additive (ppm) | | | | | |
|---|---|---|---|---|---|---|
| | | | 1,2- | | Tensile | |
| | | 2-Phenyl | Dimethyl | Modulus | Strength | Elongation |
| Classification | Imidazole | imidazole | imidazole | (GPa) | (MPa) | (%) |
| Example 2-1 | 1,500 | — | — | 6.16 | 240 | 28.2 |
| Example 2-2 | 5,000 | — | — | 6.02 | 238 | 17.8 |
| Comparative | — | — | — | 5.98 | 201 | 11.9 |
| Example 2-1 | | | | | | |
| Comparative | — | 5,000 | — | 4.62 | 189 | 12.35 |
| Example 2-4 | | | | | | |
| Comparative | — | — | 5,000 | 6.2 | 225 | 9.8 |
| Example 2-5 | | | | | | |

According to Table 3, it could be confirmed that the polyimide film prepared from the polyamic acid composition having 100 mol % of BPDA, 70 mol % of PPD, and 30 mol % of ODA had a modulus of 6 GPa or more, a tensile strength of 230 MPa or more, and an elongation of 17% or more when imidazole was used as an additive (Examples 2-1 and 2-2). On the other hand, it could be confirmed that when the additive was not used (Comparative Example 2-1) or when 2-phenylimidazole and 1,2-dimethylimidazole were used as the additive (Comparative Examples 2-4 and 2-5), mechanical properties were lower than when imidazole was used as an additive (Examples 2-1 and 2-2).

### Experimental Example 2. Evaluation of Processability

### (1) Confirmation of Electrospinnability

The electrospinnability (processability) of the polyamic acid compositions according to Examples 1-1 to 1-9 and Comparative Examples 1-1 to 1-6 was evaluated based on images obtained with scanning electron microscope (SEM) after electrospinning, and the results are shown in Table 4 below.

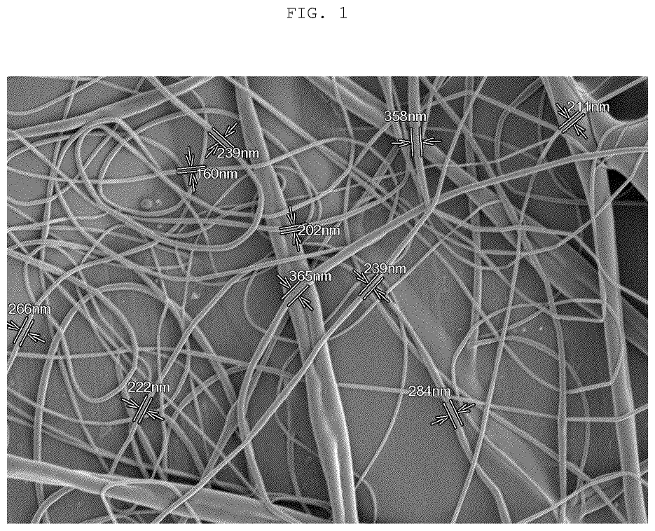

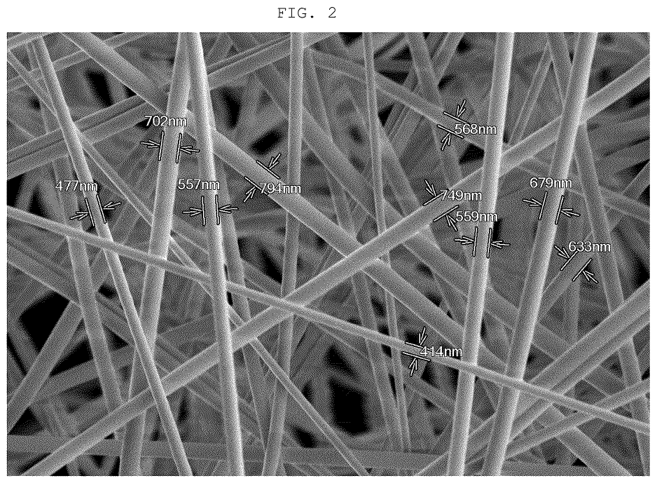

FIG. 1 is a SEM image of a polyamic acid composition prepared according to Example 1-1 after electrospinning, FIG. 2 is a SEM image of a polyamic acid composition prepared according to Example 1-2 after electrospinning, and FIG. 3 is a SEM image of a polyamic acid composition prepared according to Comparative Example 1-1 after electrospinning.

According to FIG. 1, it was confirmed that the polyamic acid composition prepared according to Example 1-1 containing a small amount (1,500 ppm) of imidazole, and thus electrospinnability was slightly improved, but it was difficult to form a web. Accordingly, when the electrospinnability was improved, but web formation was difficult as shown in FIG. 1, it was indicated by ∘ in Table 4 below.

Meanwhile, the polyamic acid composition prepared according to Example 1-2 contained 5,000 ppm of imidazole, and thus further improved electrospinnability were confirmed in FIG. 2. Thus, when the electrospinnability was improved, enabling web formation as shown in FIG. 2, it was indicated by ⊚ in Table 4 below.

On the other hand, it was confirmed in FIG. 3 that Comparative Example 1-1, which did not contain imidazole in the same diamine monomer and dihydride monomer composition, had many beads-on-string structures. Accordingly, when the electrospinnability was not improved, resulting in numerous bead-on-string structures as shown in FIG. 3, it was indicated by Δ in Table 4 below. When there are many beads on string structures, it is not desirable due to poor mechanical properties.

TABLE 4

| Classification | Electrospinnability |
|---|---|
| Example 1-1 | ◯ |
| Example 1-2 | ⊚ |
| Example 1-3 | ⊚ |
| Example 1-4 | ◯ |
| Example 1-5 | ◯ |
| Example 1-6 | ◯ |
| Example 1-7 | ◯ |
| Example 1-8 | ◯ |
| Example 1-9 | ◯ |
| Comparative Example 1-1 | Δ |
| Comparative Example 1-2 | X |
| Comparative Example 1-3 | X |
| Comparative Example 1-4 | Δ |
| Comparative Example 1-5 | Δ |
| Comparative Example 1-6 | X |

In the electrospinnability of Table 4, each symbol means the following:
⊚ indicates improved electrospinnability, enabling web formation
∘ indicates improved electrospinnability; but web formation remained difficult
Δ indicates that numerous bead-on-string structures were formed due to the lack of improvement in electrospinnability.
X indicates that electrospinning could not be performed.

According to Table 4, it could be confirmed that the polyamic acid composition of the present disclosure exhibited improved electrospinnability by containing imidazole, and in particular, when 0.5 parts by weight (5,000 ppm) or 1 part by weight (10,000 ppm) of imidazole was contained based on 100 parts by weight of the polyamic acid, the electrospinnability was improved to the extent that web formation was achieved.

### (2) Confirmation of Frozen Storage

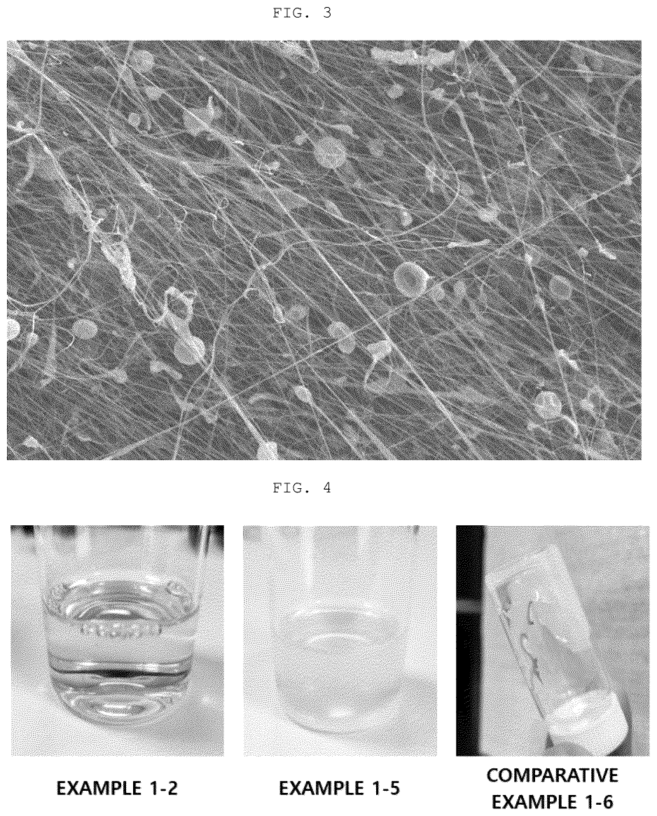

Images of Examples 1-2, Examples 1-5, and Comparative Examples 1-6 after storage in a freezer (−15° C.) are shown in FIG. 4.

According to FIG. 4, it was observed that Example 1-2 containing 5,000 ppm of imidazole showed no change over time after storage for 7 days in a freezer, and Example 1-5 containing 50,000 ppm of imidazole exhibited no haze within 2 days of frozen storage, but haze appeared after 2 days or more.

Meanwhile, it was confirmed that Comparative Examples 1 to 6 containing 51,000 ppm of imidazole formed a gel after 6 hours.

From these results, it was confirmed that when the imidazole amount was 50,000 ppm or less, stable transparency was maintained for two days or more, but when the amount exceeded this range, haze and gel formation occurred in only six hours, rapidly reducing the frozen storage properties. Therefore, it was confirmed that even a slight amount difference of about 1,000 ppm showed a remarkable difference in stability.

In other words, the polyamic acid composition according to the present disclosure includes an appropriate amount of the additive containing imidazole, and thus does not cause any change over time even after frozen storage, thereby maintaining excellent electrospinnability (processability).

In the present specification, the detailed description of the contents capable of being sufficiently recognized and inferred by those skilled in the art of the present disclosure are omitted, and many variations and modification can be made within a range that does not change the technical spirit or essential configuration of the present disclosure in addition to the specific exemplary embodiments described in the present specification. Therefore, the present disclosure may also be practiced in a manner different from that specifically described and illustrated herein, which can be understood by those skilled in the art.

1. A polyamic acid composition comprising:
a polyamic acid including a dianhydride monomer and a diamine monomer as polymerization units; and
an additive containing imidazole,
wherein the additive has an amount of 0.01 to 5 parts by weight based on 100 parts by weight of the polyamic acid.

2. The polyamic acid composition of claim 1, wherein the polyamic acid composition comprises the additive in an amount of 0.1 to 3 parts by weight based on 100 parts by weight of the polyamic acid.

3. The polyamic acid composition of claim 2, wherein the polyamic acid composition comprises the additive in an amount of 0.5 to 1 part by weight based on 100 parts by weight of the polyamic acid.

4. The polyamic acid composition of claim 1, wherein the dianhydride monomer comprises at least one selected from the group consisting of
biphenyl tetracarboxylic dianhydride (BPDA), pyromellitic dianhydride (PMDA), 3,3′,4,4′-benzophenonetetracarboxylic dianhydride (BTDA), oxydiphthalic dianhydride (ODPA), diphenylsulfone-3,4,3′,4′-tetracarboxylic dianhydride (DSDA), bis(3,4-dicarboxyphenyl)sulfide dianhydride, 2,2-bis(3,4-dicarboxyphenyl)-1,1,1,3,3,3-hexafluoropropane dianhydride, 2,3,3′,4′-benzophenonetetracarboxylic dianhydride, bis(3,4-dicarboxyphenyl)methane dianhydride, 2,2-bis(3,4-dicarboxyphenyl)propane dianhydride, p-phenylenebis(trimellitic monoester acid anhydride), p-biphenylenebis(trimellitic monoester acid anhydride), m-terphenyl-3,4,3′,4′-tetracarboxylic dianhydride, p-terphenyl-3,4,3′,4′-tetracarboxylic dianhydride, 1,3-bis(3,4-dicarboxyphenoxy)benzene dianhydride, 1,4-bis(3,4-dicarboxyphenoxy)benzene dianhydride, 1,4-bis(3,4-dicarboxyphenoxy)biphenyl dianhydride, 2,2-bis[(3,4-dicarboxyphenoxy)phenyl]propane dianhydride (BPADA), 2,3,6,7-naphthalenetetracarboxylic acid dianhydride, 1,4,5,8-naphthalenetetracarboxylic dianhydride, and 4,4′-(2,2-hexafluoroisopropylidene)diphthalic acid dianhydride.

5. The polyamic acid composition of claim 1, wherein the dianhydride monomer comprises 90 mol % or more of biphenyl tetracarboxylic dianhydride (BPDA) based on a total of 100 mol % of the dianhydride monomer.

6. The polyamic acid composition of claim 1, wherein the diamine monomer comprises at least one selected from the group consisting of
4,4′-diaminodiphenyl ether (4,4′-ODA), 1,4-diaminobenzene (PPD), 2,2′-bis(trifluoromethyl)-4,4′-diaminobiphenyl (TFMB), 2,2′-dimethyl-4,4′-diaminobiphenyl (m-tolidine), 2,2-bisaminophenoxyphenylpropane (BAPP), metaphenylenediamine, 3,3′-dimethylbenzidine, 2,2′-dimethylbenzidine, 2,4-diaminotoluene, 2,6-diaminotoluene, 3,5-diaminobenzoic acid (DABA), 3,3′-dimethyl-4,4′-diaminobiphenyl, 3,3′-dimethyl-4,4′-diaminodiphenylmethane, 3,3′-dicarboxy-4,4′-diaminodiphenylmethane, 3,3′,5,5′-tetramethyl-4,4′-diaminodiphenylmethane, 4,4′-diaminobenzanilide, 3,3′-dimethoxybenzidine, 2,2′-dimethoxybenzidine, 3,3′-diaminodiphenyl ether, 3,3′-diaminodiphenyl sulfide, 3,4′-diaminodiphenyl sulfide, 4,4′-diaminodiphenyl sulfide, 3,3′-diaminodiphenyl sulfone, 3,4′-diaminodiphenyl sulfone, 4,4′-diaminodiphenyl sulfone, 3,3′-diaminobenzophenone, 4,4′-diaminobenzophenone, 3,3′-diamino-4,4′-dichlorobenzophenone, 3,3′-diamino-4,4′-dimethoxybenzophenone, 3,3′-diaminodiphenylmethane, 3,4′-diaminodiphenylmethane, 4,4′-diaminodiphenylmethane, 2,2-bis(3-aminophenyl)propane, 2,2-bis(4-aminophenyl)propane, 2,2-bis(3-aminophenyl)-1,1,1,3,3,3-hexafluoropropane, 2,2-bis(4-aminophenyl)-1,1,1,3,3,3-hexafluoropropane, 3,3′-diaminodiphenylsulfoxide, 3,4′-diaminodiphenylsulfoxide, 4,4′-diaminodiphenylsulfoxide, 1,3-bis(3-aminophenyl)benzene, 1,3-bis(4-aminophenyl)benzene, 1,4-bis(3-aminophenyl)benzene, 1,4-bis(4-aminophenyl)benzene, 1,3-bis(4-aminophenoxy)benzene (TPE-R), 1,4-bis(3-aminophenoxy)benzene (TPE-Q), 1,3-bis(3-aminophenoxy)-4-trifluoromethylbenzene, 3,3′-diamino-4-(4-phenyl)phenoxybenzophenone, 3,3′-diamino-4,4′-di(4-phenylphenoxy)benzophenone, 1,3-bis(3-aminophenylsulfide)benzene, 1,3-bis(4-aminophenylsulfide)benzene, 1,4-bis(4-aminophenylsulfide)benzene, 1,3-bis(3-aminophenylsulfone)benzene, 1,3-bis(4-aminophenylsulfone)benzene, 1,4-bis(4-aminophenylsulfone)benzene, 1,3-bis[2-(4-aminophenyl)isopropyl]benzene, 1,4-bis[2-(3-aminophenyl)isopropyl]benzene, 1,4-bis[2-(4-aminophenyl)isopropyl]benzene, 3,3′-bis(3-aminophenoxy)biphenyl, 3,3′-bis(4-aminophenoxy)biphenyl, 4,4′-bis(3-aminophenoxy)biphenyl, 4,4′-bis(4-aminophenoxy)biphenyl, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, bis[3-(3-aminophenoxy)phenyl]ketone, bis[3-(4-aminophenoxy)phenyl]ketone, bis[4-(3-aminophenoxy)phenyl]ketone, bis[4-(4-aminophenoxy)phenyl]ketone, bis[3-(3-aminophenoxy)phenyl]sulfide, bis[3-(4-aminophenoxy)phenyl]sulfide, bis[4-(3-aminophenoxy)phenyl]sulfide, bis[4-(4-aminophenoxy)phenyl]sulfide, bis[3-(3-aminophenoxy)phenyl]sulfone, bis[3-(4-aminophenoxy)phenyl]sulfone, bis[4-(3-aminophenoxy)phenyl]sulfone, bis[4-(4-aminophenoxy)phenyl]sulfone, bis[3-(3-aminophenoxy)phenyl]methane, bis[3-(4-aminophenoxy)phenyl]methane, bis[4-(3-aminophenoxy)phenyl]methane, bis[4-(4-aminophenoxy)phenyl]methane, 2,2-bis[3-(3-aminophenoxy)phenyl]propane, 2,2-bis[3-(4-aminophenoxy)phenyl]propane, 2,2-bis[4-(3-aminophenoxy)phenyl]propane, 2,2-bis[3-(3-aminophenoxy)phenyl]-1,1,1,3,3,3-hexafluoropropane, 2,2-bis[3-(4-aminophenoxy)phenyl]-1,1,1,3,3,3-hexafluoropropane, 2,2-bis[4-(3-aminophenoxy)phenyl]-1,1,1,3,3,3-hexafluoropropane, and 2,2-bis[4-(4-aminophenoxy)phenyl]-1,1,1,3,3,3-hexafluoropropane.

7. The polyamic acid composition of claim 1, wherein the diamine monomer comprises 50 mol % or more of 1,4-diaminobenzene (PPD) based on a total of 100 mol % of the diamine monomer.

8. The polyamic acid composition of claim 1, wherein the diamine monomer comprises 50 mol % or less of 4,4′-diaminodiphenyl ether (ODA) based on a total of 100 mol % of the diamine monomer.

9. The polyamic acid composition of claim 1, wherein the polyamic acid composition has a modulus of 4 GPa or more after curing.

10. The polyamic acid composition of claim 1, wherein the polyamic acid composition has a tensile strength of 180 MPa or more after curing.

11. The polyamic acid composition of claim 1, wherein the polyamic acid composition has an elongation of 9% or more after curing.

12. A polyimide comprising a cured product of the polyamic acid composition according to claim 1.

13. A polyimide film prepared using the polyamic acid composition according to claim 1.
